(19) United States
(12) Patent Application Publication
(10) Pub. No.: US 2006/0259445 A1
(43) Pub. Date: Nov. 16, 2006

(54) METHOD OF PAYING FOR A FRANKING SERVICE IN A SELF-SERVICE MAIL-HANDLING MACHINE

(75) Inventors: Fabien CHATTE, Neogent Sur Marne (FR); Lionel Diot, Antony (FR); David Ramirez, Le Perreux Sur Marne (FR)

Correspondence Address: SUGHRUE MION, PLLC, 2100 PENNSYLVANIA AVENUE, N.W., SUITE 800, WASHINGTON, DC, 20037, US

(73) Assignee: NEOPOST Technologies, Bagneux (FR)

(21) Appl. No.: 11/419,325

(22) Filed: May 19, 2006

(30) Foreign Application Priority Data
May 20, 2005 (FR) 0505097

(51) Int. Cl. G06F 17/00

(52) U.S. Cl. 705/408

(57) ABSTRACT

A method of paying for a franking service in a self-service mail-handling machine, in which method a user sends a franking service payment request to a server system from a handheld communications device; after said request has been received by the server system, and after the user's access entitlements have been verified, and if said entitlements are valid, an authorization code is generated in the server system in response to the franking service payment request, and said authorization code is sent to the handheld communications device from the server system; by means of the received encrypted authorization code being read by the user on the handheld communications device, and by means of the encrypted authorization code being input into the mail-handling machine, and if said code is valid, it is possible to activate the mail-handling machine so as to enable the user to proceed with the operations necessary for implementing the requested franking service.

### TECHNICAL FIELD

The present invention relates to the field of mail handling, and it relates more particularly to a method of paying for a franking service in a self-service mail-handling machine instead of making conventional payments with coins or by card.

### STATE OF THE ART

Today, if it is desired to use a self-service mail-handling machine in a public place, it is necessary to have either coins or a prepaid card, or indeed a credit card or bank payment card. Coin-operated machines are exposed to vandalism from certain users, and are tending to disappear from public places, while machines operated by prepaid cards presuppose being in possession of a valid card credited with a sufficient monetary amount, which can constitute a difficulty when the mail-handling machine is used outside the opening hours of the public service upon which it is dependent. As for machines operated by credit cards or bank payment cards, they require a confidential code to be input, which can be problematic in a public place. In addition, incorporating a credit card reader into the mail-handling machine significantly increases the costs of manufacturing it and of operating it.

Therefore, there exists a need that is currently unsatisfied for an alternative method of payment that avoids the above-mentioned drawbacks when a mail-handling machine is used on a self-service basis in a public place.

### DISCLOSURE OF THE INVENTION

An object of the present invention is thus a novel method of paying for a franking service in a self-service mail-handling machine available in a public place, said method comprising the following steps:

a user using a handheld communications device to send to a server system a request for a franking service payment;

the server system receiving said request and verifying the user's access entitlements;

if the user's access entitlements are valid, the server system responding to the franking service payment request by encrypting an authorization code taken from a list of authorization codes sent previously to the mail-handling machine by the server system;

the server system sending the encrypted authorization code to the handheld communications device;

the user reading the received encrypted authorization code on the handheld communications device;

the user inputting the encrypted authorization code into the mail-handling machine;

the mail-handling machine verifying the encrypted authorization code input by the user; and

if said code is valid, activating the mail-handling machine so as to enable the user to proceed with the operations necessary for implementing the requested franking service.

Thus, these simple means of payment by mobile telephone avoid the above-mentioned drawbacks of payment in cash or by card.

Preferably, the step of sending the franking service payment request comprises sending an identity code of the mail-handling machine.

Depending on the implementation considered, the step of sending the franking service payment request may comprise sending a Short Message Service (SMS) message, or making a call to a voice server.

Advantageously, the step of verifying the user's access entitlements comprises verifying the telephone number of the user, the step of encrypting the authorization code comprises encryption by means of a private key of the server system, and the step of verifying the encrypted authorization code comprises decrypting the encrypted authorization code by means of a public key associated with the private key of the server system and then comparing the resulting authorization code with an authorization code taken from a list of authorization codes received previously from the server system.

Preferably, the mail-handling machine periodically transmits to the server system a correspondence table which, for each authorization code, gives the franking transaction amount consumed by the user of the code. Said table also includes a transaction date and a statement of the various operations relating to the requested franking service. The transmission takes place at least once per day.

Advantageously, in response to said transmission, the server system returns to the mail-handling machine a new list of authorization codes and a new public key. The server system generates an allocation table that associates the telephone number of a user whose access entitlements are valid with an authorization code from the list of authorization codes corresponding to the machine to which the user wishes to gain access.

Preferably, the user is invoiced by associating the user telephone number from the allocation table with a franking transaction amount from the correspondence table, the link between the two tables being established by their common authorization code.

### BRIEF DESCRIPTION OF THE DRAWINGS

Other characteristics and advantages of the present invention appear more clearly from the following description given by way of non-limiting indication, and with reference to the accompanying drawings, in which:

FIG. 1 is an example of network architecture making it possible to implement the method of the invention for paying for a franking service;

FIG. 2 is a flow chart showing the various steps of the method of the invention; and

FIG. 3 shows an example of how the database implemented in the method of the invention is organized.

### IMPLEMENTATION(S) OF THE INVENTION

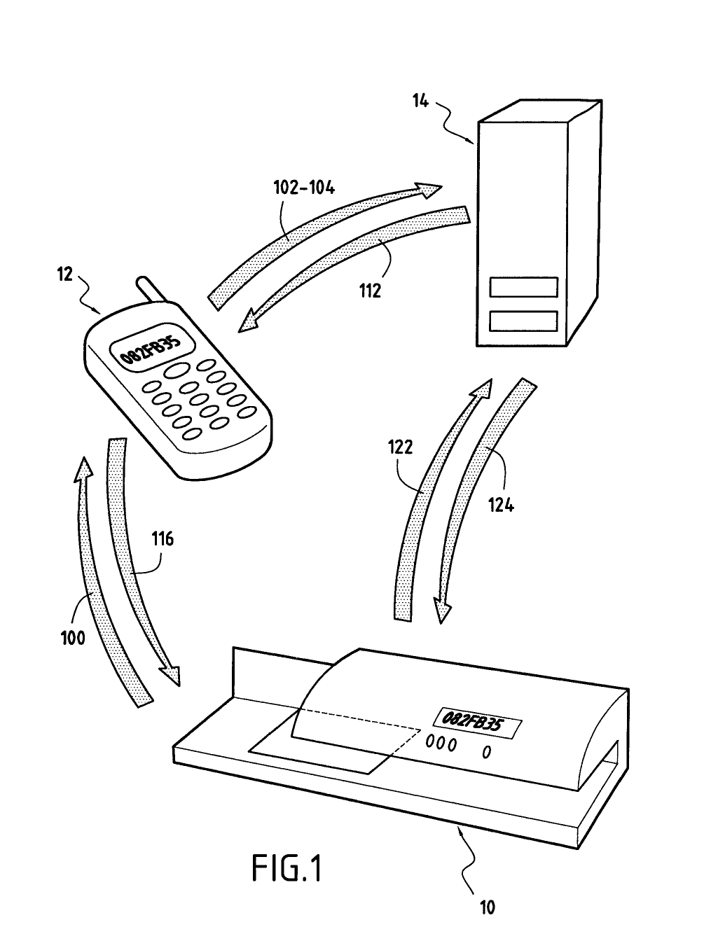

The principle of the invention is based on replacing the current cash or card payment for franking services in self-service franking machines or postage meters with payment by means of a handheld communications device. For this purpose, and as shown in FIG. 1, it is proposed to a user of a mail-handling machine 10 who wishes to frank one or more mail items to read off the identity number of the machine, to call a service for paying for a franking service, and to communicate the identity number, by means of the handheld communications device 12 in the possession of the user, to a franking service payment server system 14 indicated by an identifier of the service, to receive on the handheld communications device, in response to communicating the identity number, an encrypted code for authorizing franking, and to input the franking authorization code into the mail-handling machine so as to validate the desired franking services, the amount of the franking transaction relating the requested service(s) being debited directly from the account held by the user with the payment service for paying for the franking service.

The mail-handling machine 10 is a standard connected machine disposed in a public place and thus for self-service use. Optionally, it can incorporate a weighing module and it has a user interface. The user interface makes it possible to view and to input various items of information relating to the desired franking service (machine identity number, amount of the franking transaction, class of mail, carrier used, country of destination, desired logo, etc.) displayed by the machine or input by the user. It thus includes at least one screen which can then be touch-sensitive or more conventionally a liquid crystal diode (LCD) associated with a keypad having function keys.

The handheld communications device 12 can be any data-processor device making it possible to perform wireless communications through a wireless telecommunications network (such as the following networks: Global System for Mobile Communications (GSM), Universal Mobile Telecommunications System (UMTS), Worldwide Interoperability for Microwave Access (WIMAX), etc.) such as a mobile or portable telephone or “cellphone”, a communicating personal digital assistant, or indeed a communicating portable computer or “laptop”.

The server system 14 disposed on a site of the operator of the mail-handling machine or on the site of the postal administration comprises one or more central processing units containing one or more databases and conventionally one or more computer terminals (not shown) for the purposes of controlling and managing the system. Naturally, the server system has the necessary interfaces (SMS, voice, Wireless Application Protocol (WAP), Internet, etc.) in order to enable communications to be established with the handheld communications device using the desired protocols.

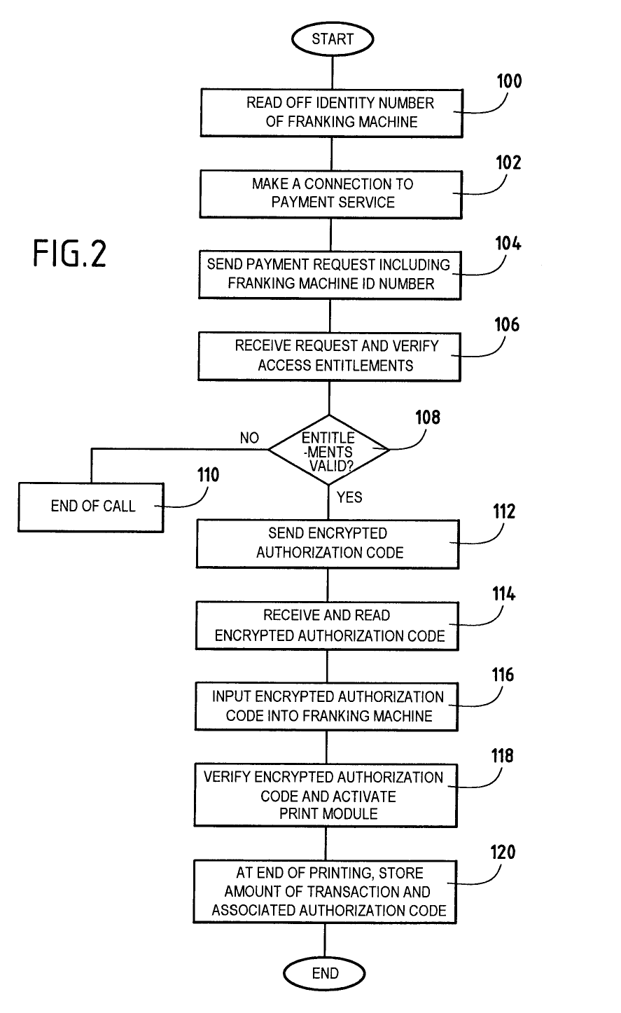

FIG. 2 is a flow chart showing the various steps making it possible to unlock the mail-handling machine in order to allow the user to perform franking operations (see also FIG. 1). In a first step 100, the user reads off the identity number of the mail-handling machine that the user wishes to use for the requested franking service. Said number can be marked on the machine or, more simply, it can appear on its viewing screen when the user activates the machine. Such activation can also cause the screen to display the identifier of the franking service payment service to which the user must make a connection, in a step 102 in order to obtain franking authorization. The identifier is, for example, a telephone number or a short number (but it is possible to imagine using a WAP or Internet address) that the user must call by means of the handheld communications device in order to input into communication with the server system associated with the franking service payment service.

Once connection is established, the user sends to the server system, in a step 104, a franking service payment request including the identity number of the mail-handling machine as read off previously, the form of the call or communication naturally depending on the type of interface used at the server system, which interface can be an interface for an interactive voice server, for an SMS server, for a WAP or Internet server, or for any other suitable server.

In another step 106, the server system receives said request and verifies that the user is entitled to access the service, e.g. by comparing the user telephone number with the number recorded in its customer database. This comparison can be made conventionally on the basis of the International Mobile Subscriber Identity (IMSI) number or International Mobile Equipment Identity (IMEI) number of the communications device, which number is transmitted during the call. If the answer to the comparison (test at step 108) is “no”, the server system asks the user whom it has not been able to identity to apply for registration to the service by any suitable communications means (over a counter, by telephone, via the Internet) and the call is then interrupted (step 110). Otherwise, if the user's access entitlements are valid, and in response to the franking service payment request, the server system generates, in step 112, an encrypted authorization code (by using a private key of the server system to encrypt an authorization code taken from a list of authorization codes sent previously to the mail-handling machine in question) which code is a unique code that is self-signed on the basis, in particular, of the identity number of the mail-handling machine, which identity number is received with the request, and said server system sends said encrypted authorization code to the handheld communications device. The user then, in a new step 114, merely has to read the encrypted authorization code received on the handheld communications device and to input it, in a next step 116, into the user interface of the mail-handling machine so that, in a next step 118, the mail-handling machine verifies the encrypted authorization code input by the user, and, if that code is valid, activates the print module of the mail-handling machine so as to enable the user to proceed with the franking operations, whose total amount at the end of printing is stored with the corresponding authorization code in the mail-handling machine (step 120).

The verification operation is performed by decrypting the encrypted code by means of a public key associated with the private key of the server system and by comparing the obtained result with a list of authorization codes received previously from the server system.

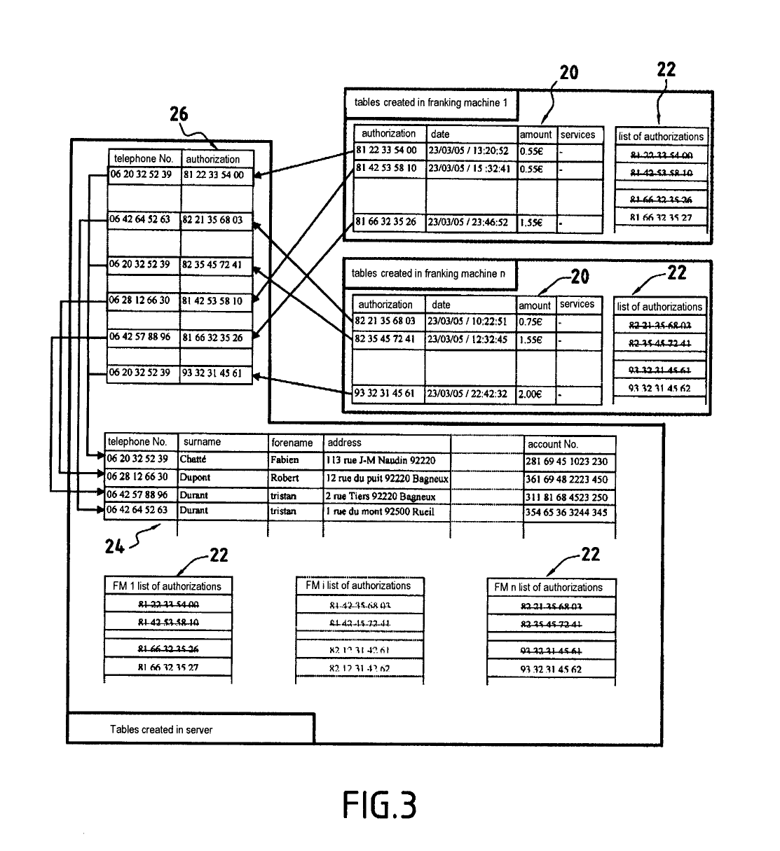

The printing operation is quite conventional and consists, for the user, in placing the first mail item that is to be franked in the mail-handling machine, and, by following the instructions given by the machine, in selecting, at the user interface, the various operations necessary for implementing the requested franking service such as determining the destination of the mail item or the desired class (e.g. second class, or registered or recorded-delivery), the choice of the desired carrier (e.g. Chronopost®), of the logo or of the advertising slogan required, optionally as well as the class of weight when a weighing module is not available. The mail-handling machine then generates a time-stamped code on the basis of that information, in particular of the computed amount of the franking transaction, and of its identity number, which code is then affixed (on its own or with a conventional postage imprint) on the mail item so as to guarantee the validity of it and to guarantee subsequent processing and handling by the postal administration. This franking operation can be repeated until all of the mail items of the user are franked, the user indicating to the mail-handling machine, via the user interface, that the operations are complete, thereby leading to deactivation of the print module of the mail-handling machine, to storage of the consumed amount for the franking transaction, and to termination of validity of the encrypted authorization code. Each encrypted authorization code is thus associated with the franking transaction amount consumed by the user and corresponding to the requested franking service(s). These two elements (code and amount) as well as the date of the transaction, and the itemized statement of the various service options used are stored in the secure portion of the mail-handling machine in a database 20 whose structure is shown in FIG. 3 and whose contents are transferred at least once per day to the server system in order to enable the user to be invoiced (reference 122 in FIG. 1). In return, the server system sends to the mail-handling machine a list 22 of authorization codes valid for the next franking operations and a new public key necessary for decrypting the encrypted codes received from the user (reference 124 in FIG. 1).

It should be noted that each self-service mail-handling machine belonging to the franking service payment service has its own database and its own list of authorization codes.

The server system is organized around two databases. A first database 24 contains information relating to the various customers of the franking service payment service. For example, it can contain the surname, forename, and address of each customer, the telephone number and the customer account number of each customer, and any other information (e.g. the balance of the account of each customer) enabling the customer to be identified properly. A second database 26 contains a dynamic allocation table which allocates an authorization code to each telephone number of a user connecting up to the service, the authorization code being taken from the list of authorization codes of the mail-handling machine of which the user has given the identity number.

On the basis of the authorization code present in the two databases, the server system can then establish a link between them and thus make it possible to invoice the user by associating a determined franking transaction amount with a determined telephone number.

1. A method of paying for a franking service in a self-service mail-handling machine, said method comprising the following steps:
a user using a handheld communications device to send to a server system a request for a franking service payment;
the server system receiving said request and verifying the user's access entitlements;
if the user's access entitlements are valid, the server system responding to the franking service payment request by encrypting an authorization code taken from a list of authorization codes sent previously to the mail-handling machine by the server system;
the server system sending the encrypted authorization code to the handheld communications device;
the user reading the received encrypted authorization code on the handheld communications device;
the user inputting the encrypted authorization code into the mauhandling machine;
the mail-handling machine verifying the encrypted authorization code input by the user; and
if said code is valid, activating the mail-handling machine so as to enable the user to proceed with the operations necessary for implementing the requested franking service.

2. A method according to claim 1, wherein the step of sending the franking service payment request comprises sending an identity code of the mailhandling machine.

3. A method according to claim 1, wherein the step of sending the franking service payment request comprises sending a Short Message Service (SMS) message.

4. A method according to claim 1, wherein the step of sending the franking service payment request comprises making a call to a voice server.

5. A method according to claim 1, wherein the step of verifying the user's access entitlements comprises verifying the telephone number of the user.

6. A method according to claim 1, wherein the step of encrypting the authorization code comprises encryption by means of a private key of the server system.

7. A method according to claim 6, wherein the step of verifying the encrypted authorization code comprises decrypting the encrypted authorization code by means of a public key associated with the private key of the server system and then comparing the resulting authorization code with an authorization code taken from a list of authorization codes received previously from the server system.

8. A method according to claim 6, wherein the mail-handling machine periodically transmits to the server system a correspondence table which, for each authorization code, gives the franking transaction amount consumed by the user of the code.

9. A method according to claim 8, wherein said table also includes a transaction date and a statement of the various operations relating to the requested franking service.

10. A method according to claim 8, wherein the transmission takes place at least once per day.

11. A method according to claim 8, wherein, in response to said transmission, the server system returns to the mail-handling machine a new list of authorization codes and a new public key. allocation table with a franking transaction amount from the correspondence table, the link between the two tables being established by their common authorization code.
